(19) United States
(12) Patent Application Publication
(10) Pub. No.: US 2013/0275695 A1
(43) Pub. Date: Oct. 17, 2013

(54) BACKUP AND STORAGE SYSTEM

(71) Applicants: Simon Ponsford, Doha (QA); Simon Guerrero, Doha (QA)

(72) Inventors: Simon Ponsford, Doha (QA); Simon Guerrero, Doha (QA)

(73) Assignee: Qatar Foundation, Doha (QA)

(21) Appl. No.: 13/468,953

(22) Filed: May 10, 2012

(30) Foreign Application Priority Data
Apr. 12, 2012 (GB) 1206443.2

(51) Int. Cl. G06F 12/16

(52) U.S. Cl. 711/162; 711/E12.103

(57) ABSTRACT

A computer-implemented method of backing up data comprises selecting a local file stored on a client device to be backed-up, encoding the file into multiple fragments, transmitting the multiple fragments from the client device to a plurality of remote storage areas, storing the multiple fragments at the remote storage areas.

### CROSS REFERENCE TO RELATED APPLICATIONS

This application claims foreign priority from UK Patent Application Serial No. 1206443.2, filed 12 Apr. 2012.

### BACKGROUND

It is desirable to have a certain level of backup or redundancy to rely upon when storing and managing data. For example, it is often necessary to maintain multiple copies of data, preferably in different locations or across physically distinct hardware, in case an event results in irreparable damage to one or more of the copies of the data.

However, maintaining data storage at multiple locations is expensive and time-consuming. As an alternative, third-parties can be used to provide off-site data storage. Cloud storage services are one type of off-site data storage. Cloud storage services are data storage services available via a wide-area network. Cloud storage services typically provide storage to users in the form of a virtualized storage device available via the Internet. In general, users access cloud storage to store and retrieve data using suitable web services protocols.

Cloud storage service providers manage the operation and maintenance of the physical data storage devices. Users of cloud storage can avoid the initial and ongoing costs associated with buying and maintaining storage devices. Cloud storage services typically charge users for consumption of storage resources, such as storage space and/or transfer bandwidth, on a marginal or subscription basis, with little or no upfront costs. In addition to the cost and administrative advantages, cloud storage services often provide dynamically scalable capacity to meet their users' changing needs.

### SUMMARY

According to an example, there is provided a computer-implemented method of backing up data comprising selecting a local file stored on a client device to be backed-up, encoding the file into multiple fragments, transmitting the multiple fragments from the client device to a plurality of remote storage areas, storing the multiple fragments at the remote storage areas. Storing the multiple fragments includes storing all the fragments of the file. The method can further include transmitting the multiple fragments to a storage manager, the storage manager to distribute a fragment to a remote storage area. A file fragment can be encrypted prior to distribution from the storage manager. A list of suitable storage areas can be maintained at the client device. Data can be received at the client device from a remote storage area indicating that a fragment has been successfully received and stored.

According to an example there is provided a system for redundant cloud storage comprising a processor coupled to a memory to retain computer-executable instructions, the processor to execute a client device component to generate backup data representing a fragment of a data file for backup, and a cloud backup storage manager to receive the fragment and to distribute it to respective ones of a set of cloud storage devices in accordance with a preference file for selecting multiple ones of cloud storage devices. The client device can compress the backup data and transmit it to the cloud backup storage manager with checksum data for the backup data. The cloud backup storage manager can validate the checksum data, identify a cloud storage device for the fragment, encrypt the fragment, and transmit the encrypted fragment to the identified cloud storage device for storage. A configuration database can receive data from the cloud backup storage manager indicating successful storage of the encrypted fragment at the identified cloud storage device. The cloud backup storage manager can provide a success response to the client device to indicate successful storage of the fragment.

According to an example, there is provided a device suitable for use with any of the methods and systems described herein, such as a mobile device.

According to an example, there is provided a computer program embedded on a non-transitory tangible computer readable storage medium, the computer program including machine readable instructions that, when executed by a processor, implement a method for backing up data, comprising, selecting a local file stored on a client device to be backed-up, encoding the file into multiple fragments, transmitting the multiple fragments from the client device to a plurality of remote storage areas, storing the multiple fragments at the remote storage areas.

### BRIEF DESCRIPTION OF THE DRAWINGS

An embodiment of the invention will now be described, by way of example only, and with reference to the accompanying drawings, in which:

FIG. 1 is a schematic block diagram of an overview of a system according to an example;

FIG. 2 is a schematic block diagram of a system according to an example;

FIG. 3 is a flowchart of a method according to an example; and

FIG. 4 is a schematic block diagram of a device according to an example.

### DETAILED DESCRIPTION

It will be understood that, although the terms first, second, etc. may be used herein to describe various elements, these elements should not be limited by these terms. These terms are only used to distinguish one element from another. For example, a first gesture could be termed a second gesture, and, similarly, a second gesture could be termed a first gesture.

The terminology used herein is for the purpose of describing particular examples only and is not intended to be limiting. As used herein, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

A backup system according to an example includes a number of provisions. For example, multiple fragments of a file can be backed-up across several cloud storage areas, thereby replicating fragments so that the loss of one storage area can be mitigated by retrieving a copy from another site. This is useful where, for instance, most files are backed-up to a local filestore with occasional use of a higher-cost, higher-reliability storage system for additional copies of the most important files.

Fragments making up a file can be written across a number of cloud storage areas using, for example, a RAID 5 pattern, allowing for the failure of part of the storage. This is useful where all the storage areas can be categorised in terms of having roughly equal levels of reliability, but comes at a cost of an increase in fragment size.

Multiple providers of cloud storage can be used to store a distributed, encrypted file system. This allows a file system to move between the cloud and a user's device through a process of backing up and/or restoring files which have been changed during a login session.

It is possible to use a system and method as described herein to underpin a resilient content delivery network (CDN), allowing location-independent delivery of streaming content. For example, a dynamic name resolution system may be used to redirect an apparently static request URL to the most appropriate copy of the required content. Combined with multiple content servers behind a virtual IP address, this can enable (potentially seamless) recovery in the event of loss of a data store, a server, or both.

A system and method in example can provide the ability to recover the last version of all backed-up files using a single operation. This can be useful in the event of the loss of a particular computer system. Also, because files can be fragmented across multiple systems, a backup or restoration request can be parallelised to minimise operation time. In addition to functionality integrated into a client device such as a desktop for example, a browser-based interface can permit full access to the same functionality, including saving and restoring file versions, registering and de-registering desktop systems (for example, in the case of loss or theft of a computer) and so on.

According to an example, a system comprises of a number of distinct components:

i) A Storage manager to provide a set of services which are typically exposed via a web service interface, and used to co-ordinate authentication, storage and retrieval of files, as well as running monitoring activities.
ii) A configuration database in the form of a clustered database which resides on a set of database servers and which is operable to store user information (including keys, passwords, preferences and details of backed-up files) and also system configuration (available storage locations and their characteristics).
iii) A set of agents to handle the physical storage and retrieval of file fragments as instructed by the Storage manager. For commercial cloud providers such agents can be managed by the provider and accessed via web service calls as specified by the provider. For generic storage, a Custom Storage Agent (described below) can be installed on either a physical or virtual server which has access to the storage, and communicates with the Storage manager through a web service interface for example.
iv) A client system “tray application” which can be installed on a client system or device to handle authentication, scheduled backups and user preferences. In an example, integrated “right-click” context menus can provide a user with access to backup and restore operations directly from the desktop.
v) A management interface to provide the ability to manage aspects of the system, from user administration up to storage management, and also to permit a user to access his or her files from a different system from that originally used to back them up. Access to this interface can be provided via a web browser, connecting to a web server hosted on an Administration server cluster. In the case of a mobile device for example, a web browser or a locally installed application such as for example a mobile app can be provided.

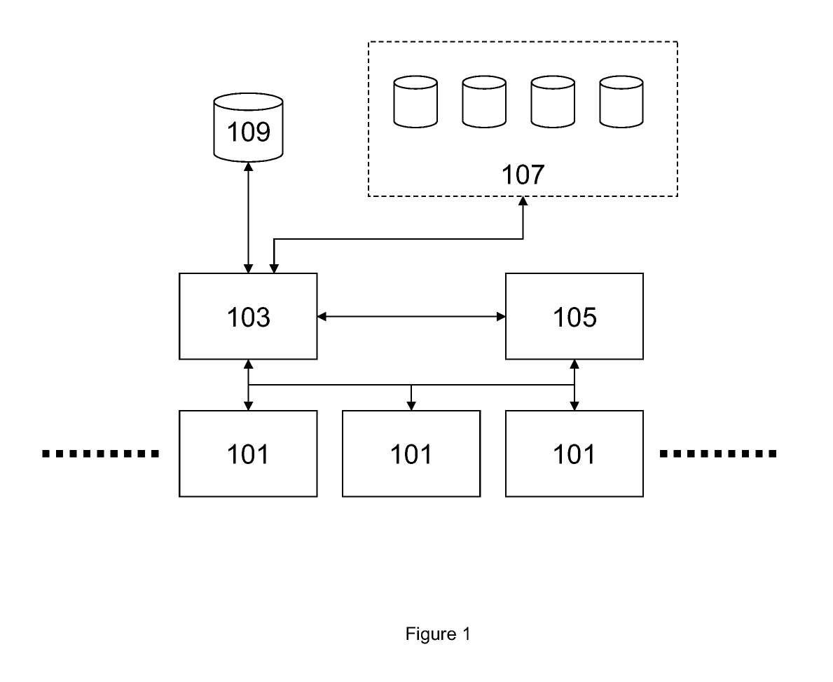

FIG. 1 is a schematic block diagram of an overview of a system according to an example. In the example of FIG. 1, a storage manager component has access to a number of commercial cloud storage datacentres (via suitable APIs for example), an internal company datacentre (again via a suitable API) and some internally available disk storage (via a Custom Storage Agent running on a host server).

Multiple client system devices 101 are communicatively coupled to an administration server 103 and a storage manager component 105. For example, a client device 101 can send and receive data over the internet using a wired or wireless link. Data can be sent and received from a server 103 and manager 105 using a secure link such as HTTPS for example. Storage manager 105, which can be a server which is remote from and/or physically distinct from server 103 is communicatively coupled to a set of cloud storage devices/remote storage areas 107. The cloud storage devices can include multiple storage devices provided by third parties and which are accessible via a provider API for example. In an example, network storage 109 can be included and operable to receive a fragment of a file for backup from a client device 101.

In an example, in order to backup a data file, a user must first be registered with a database of the Storage Manager 105. Typically, each user is associated with a Service Level, which defines the level of resilience available to them (such as how many copies of each backup will be made for example) and the total amount of storage which is available to them. Client software in the form of a tray application and context menu functions for example is provided on a client system, via web browser (served by the Administration Server). In an example, a user can install such software.

Typically, each user is allocated a unique key pair which is used by the Storage Manager 105 to encrypt and decrypt file fragments as they move to and from the storage areas 107. This ensures that anyone able to access an individual file fragment on a particular system cannot decrypt it without the private key, and the storage of the key in the configuration database means that there is no risk of it being lost by an end user.

Client software enables tightly-integrated backup and recovery functionality from context menus on a user device such as desktop computer, laptop or mobile device such as a mobile station or tablet device for example. During the installation process, a username and password and/or private key of the user is used to authenticate against the Storage Manager 105 and to authorise the machine upon which it is being installed. This causes the current device to be added to a list of authorised systems within a database stored on the storage manager 105. If the device in question is lost, stolen or otherwise rendered inaccessible at any point in the future, the administration interface can be used to replace the machine with a new system, allowing recovery of a system's files and continuation of service. Once the software is installed on a system and that system has been registered with the Storage Manager 105, the backup functionality is made available via system context menus. In an example, a system tray application also provides access to changing application behaviour preferences.

According to an example, to back up a file, the user right-clicks on the file and selects “Backup” (or similar) from a context menu. If a session token does not exist locally on the system (i.e. the user/machine combination has not been authenticated), the user will be prompted for his or her username and optionally, a password (depending on whether or not a key is being used). The software will then authenticate against the Storage manager 105 using a web service call. If authentication fails, the user is prompted again. Otherwise, the user is authenticated for the current session and a session token is stored locally. In an example, should the user have elected to use a key pair for authentication against the storage manager, this will be a different key from that used by the storage manager to encrypt and decrypt file fragments.

In an example, the client software creates a temporary, compressed version of the file selected or identified to be backed-up. It then calls a web service on the Storage manager 105, passing in a backup request along with details such as the file size. Subject to sufficient space, the Storage manager 105 determines the user's preferences in a configuration database and builds up a list of a number of storage locations 107, along with details of offsets and sizes of file fragments to be stored in those locations. This information is stored in the configuration database as a File Transfer Session object, identified by the source system name, username and file path and a file version. The Storage Manager 105 responds to the client software providing details of the locations allocated for storage and the size and offset of each of the required fragments.

In an example, the client software spawns a number of child threads, each one to transmit a fragment (up to a pre-defined limit). This allows simultaneous transmission of multiple fragments of each file without waiting for the ultimate success or failure of to store one fragment before the others can be sent. Each thread can call a web service on the Storage Manager 105, sending it a file fragment along with a checksum of the compressed data, such as a SHA-1 checksum. The Storage Manager 105 validates the checksum and identifies to which storage location(s) 107 the fragment should be sent. It then encrypts the fragment using the user's public key from the configuration database, and sends the encrypted fragment to the appropriate storage location 107 (in the case where a custom storage agent is used, another checksum can also be sent for subsequent verification by the storage agent). When the fragment has been stored successfully at the appropriate location, the details of the file and its fragments are stored in the configuration database, and a success response is returned to the client for the appropriate fragment.

The client carries on transmitting each fragment (opening additional threads if appropriate), until all are complete. During the process, the multi-threaded nature of the process means that progress can be indicated to the user in a small window, showing how much of each fragment has been stored. If a failure occurs at any point in the process (for instance, in the case of a checksum being invalid), a number of retries may occur, with the client re-sending data if appropriate. After retries have been exceeded, a critical failure is returned to the client and the operation is aborted. Any successfully stored fragments are removed from their storage locations and all data about the file version is removed from the database. Note: in the case of a failure to write to a storage location, the Storage Manager re-allocates the fragment to the next available server (and indicates this to the client). If no more storage locations are available for the fragment, this constitutes a critical failure.

In an example, to archive a file (i.e. backup and then remove the source file), a user right-can click the file in question and select “Archive” (or similar) from the context menu. The same process is followed as per backing up (above), but at the end of the process, the original file is removed and replaced with a relatively smaller file associated with the client software. This file contains sufficient information to uniquely identify the original file in the distributed backup in the cloud, should it need to be restored.

In an example, to restore a file from a backup a user can either right-click the file and click “Restore” (or similar) from the context menu (picking a version number if more than one version exists), or—in the case of an archived file—double-click on the file. This causes the reverse of the Backup process to occur—a File Restore session is started on the Storage Manager 105 and each fragment is retrieved and its checksum verified, re-constructing the original file. When complete, any existing file is renamed and the restored file put in its place, notifying the user of progress as appropriate. The user can also retrieve any archived or backed-up file via a web interface described below. This can include a “download” option to retrieve any archived file version via the web browser. In an example, a web interface can include an interface for a mobile device which can be accessible using a locally installed app for example, or via a mobile specific browser.

In an example, communication during the processing of data from client to storage locations is encrypted and authenticated as appropriate. In addition, the data itself can be encrypted independently prior to transmission to remote systems. A backed-up file resides in multiple fragments across multiple different servers. None of these fragments are individually identifiable as being part of any particular file without the use of the Storage manager 105. Furthermore, each of these fragments can only be decrypted using the private key for the user who originally backed the file up. This key is stored within the Storage Manager's configuration database and is not available externally.

In an example, all channels are encrypted, not just that between the manager and the cloud devices. The channel between the client device and the manager can be encrypted passively (such as by virtue of using secure HTTP for example), while the channel between the manager and the cloud devices is potentially ‘double-encrypted’—firstly, it can be encrypted using a public key so that anyone accessing the cloud device cannot decrypt the fragment. Secondly, it can also be encrypted by virtue of the transmission mechanism between the storage manager and the client device (again, such as using web services over secure HTTP for example). This ensures the integrity of the data against both intrusion at the end point, as well as packet sniffers en route.

Typically, all users will have a unique user ID and can opt to authenticate either with a password, a shared key or a combination of both. All traffic from a client 101 to the Storage Manager 105 can be marked with a unique session number and the name of the user's system, and is authenticated by the Storage Manager 105 before it is accepted. All web service traffic between the client software and the Storage manager can be encrypted with SSL (Shared Sockets Layer) 128-bit encryption. All communication sessions between the Storage manager 105 and a piece of storage accessed via a Custom Storage Agent are authenticated using a key pair (the Storage manager initiates all communication, sending its private key). The Custom Storage Agent is based on a small web browser, offering web services which are all accessed over secure HTTP, again encrypted with 128-bit SSL encryption. For storage accessed via providers' standard API's, the provider's encryption and authentication is used to achieve similar levels of security.

For file fragment storage, each user has a key pair, generated at the time the user was registered with the system. Both halves of the key are held by the Storage manager 105. Whenever the Storage manager 105 receives a file fragment from a client 101, it can encrypt it using the public half of the key then compresses it prior to transmission to the storage location. Likewise, when an encrypted fragment is retrieved from the storage location, the Storage manager 105 can decrypt it using the private key and decompresses it, prior to transmitting it to the client.

From a storage perspective, the system according to an example is infinitely scalable, simply by adding more storage destinations. Resilience of the storage is achieved by storing multiple copies of each file fragment (subject to the user's service level). Both the Storage manager and the configuration database can be clustered using industry-standard Linux High Availability and MySQL clustering. A load balancer can be used to direct traffic to the least used node. Commercial cloud storage vendors' interfaces are designed to be inherently scalable. Certain components and modules of a system and method according to an example will now be described in greater detail.

The Storage manager 105 comprises of a custom collection of web services which can be run on a Linux server for example, connecting to a configuration database implemented with MySQL. The default configuration of the Storage manager is a single instance on a single server, which also hosts a single-instance database. However, both the Storage manager and the configuration database can be clustered with the database hosted on one or more separate machines from the Storage manager. The configuration database is broadly divided into two sections: architecture configuration and user configuration. The architecture configuration part of the configuration database maintains details of the storage available to the Co-ordinated Cloud Storage system. These can include:
Storage provider API type
Response speed
Free space
Geographic location
Uptime percentage over last 30 days
Service profiles in which this storage is available
Contact details
Access key
Key expiry
Other configuration info needed to use

The user configuration section of the database includes all information needed to manage users and their files. Details can include:
User information—account ID, email, password, name, address, public key for login, key pair for encryption, last login, account schedule, billing details etc.
File information—user's files, fragment breakdown, location of individual fragments, timestamps, versions etc.
Provider/storage ranking (preference order when storing files)
Session information—session token, active file operations, login time and so on.

In an example, a number of web services are available for use by client applications. More specifically, a CLIENT_LOGIN message can be sent by a client to initiate a login session, and includes the user ID, machine name and password/private key. If the login is successful, a session token is returned for use in subsequent transactions. Otherwise a failure message is returned. A CLIENT_LOGOUT message is sent by the client to terminate a login session. It causes the Storage manager to invalidate the current session token. A success code is returned. A CLIENT_HEARTBEAT message is sent by the client once every five minutes to indicate that a user session still exists. In the event of the user session being closed without the client sending a CLIENT_LOGOUT message, the server will wait for ten minutes without receipt of a CLIENT_HEARTBEAT message, prior to invalidating the current session token. A CLIENT_INIT_BACKUP message is sent by the client to initialise the backing up or archiving of a file. Data supplied includes the session token, machine name, full file path, file size, a flag indicating BACKUP or ARCHIVE and any other options specific to the backup (e.g. a particular preference order). If the request is accepted, the Storage manager 105 returns a backup request token and a list of fragment offsets and sizes. This information is used by the client to send the file to the Storage manager 105. If the request is not accepted, a failure message is returned, containing details of the failure. A CLIENT_PUT_FRAGMENT message is sent by the client to deliver a single fragment of a file to the Storage manager as part of the backup sequence. Data supplied includes the session token, machine name, full file path, the backup request token (returned in the CLIENT_INIT_BACKUP response), the fragment number, the fragment data and a checksum. The Storage Manager 105 uses this data to initiate a transfer to the appropriate storage area using the vendor's API or (in the case of a custom agent) the AGENT_PUT_FRAGMENT message. A success response is returned to the client. A CLIENT_INIT_RESTORE message is sent by the client to request a restore of a particular file. The message includes data such as the session token, machine name, full file path, and optionally a specific version (or “LATEST”). If no version is supplied in the message, the Storage manager 105 returns a response containing a list of available versions. The client uses this information to request a specific version from the user, and then issue another CLIENT_INIT_RESTORE request. If a version is supplied, the Storage manager responds with a restore request token and a list of fragment offsets and sizes. This information is subsequently used by the client to request a file from the Storage manager. If the request is not accepted, a failure message is returned, containing details of the failure.

A CLIENT_GET_FRAGMENT message is sent by the client to request a single fragment of a file from the Storage manager 105, as part of a restore sequence. Data supplied includes the session token, machine name, full file path, the restore request token (returned in the CLIENT_INIT_RESTORE response) and the fragment number. When the Storage manager 105 receives the request, it identifies the location(s) where the fragment is stored, and retrieves the encrypted fragment data from the location marked as the highest priority, using either the vendor's API or, in the case of a custom agent, via a AGENT_GET_FRAGMENT message. If any fragment fails to be retrieved by the Storage manager 105 after three retries, the storage area is marked as offline in the configuration database. If any other copies exist of the fragment, the Storage manager attempts to retrieve it from the next available area. If the fragment could not be successfully retrieved from any of the storage areas, an error is returned to the client. Otherwise, details of the storage areas from which fragments could not be retrieved are returned in the response message (the client can display this information to the user to allow him or her to make a decision as to whether to make an additional copy of the file for further resilience).

In order to maintain a healthy range of storage areas, and also to rank areas in terms of speed of response and uptime, the Storage manager 105 periodically checks the responsiveness of each storage area by transmitting a small file to it in an example. This is done in the same way as when storing a data fragment—either through the API of the vendor, or by sending the AGENT_PUT_FRAGMENT message to the appropriate custom agent. If the data fragment cannot be stored, the storage area is marked as offline in the configuration database. If the storage area has been offline for more than a pre-determined maximum time period, it is flagged as requiring manual intervention via the administration interface. If the data fragment was stored successfully, the elapsed time between initiation of the fragment storage and receipt of the response message is stored in the configuration database for use in provider ranking.

According to an example, agent services handle requests for storing and retrieving file fragments. In the case of supported web storage, the Storage manager 105 corresponds with these agents using specific API requests defined by the provider. Any details needed to issue these requests (e.g. authentication keys) are stored alongside the provider record in the configuration database.

Where an area of raw disk storage is available (for example in the form of a SAN on a company network, or on hosted webspace on the internet), a custom storage agent can be used to handle storage and retrieval of file fragments. In an example, the storage agent is a small web server which can be installed on any Linux system—physical or virtual—which has access to the disk storage. Alternatively, the agent is available as a standalone machine image, based around a very small Linux installation. If required, the agent can be scaled up to provide higher availability by running multiple instances of the standalone version in a cluster, using Linux High Availability services. However, it should be noted that the use of non-standard storage should normally be considered as a secondary option after one of the commercial cloud storage systems, which will inevitably provide more resilience due to their design and scale.

In an example, communication is initiated by the Storage manager 105. It uses a private key stored within the configuration database to call a specific web service on the Custom Storage Agent, which verifies the authenticity of the key and processes the receipt or transmission of file data. The Storage manager stores a fragment by sending an AGENT_PUT_FRAGMENT message to the appropriate custom storage agent. This message includes a unique identifier for the fragment and a SHA-1 checksum. A handler application re-calculates the checksum and verifies it against the one supplied. If it matches, the fragment is stored away and a success response is returned to the Storage manager. If the operation is unsuccessful, a failure code is returned to the Storage manager 105. In the case of a checksum failure, this causes the Storage manager to retry the request a maximum of three times. If the checksum fails after all retries, if the Storage manager receives any other failure code, or if the custom storage agent did not respond in time, the storage area is marked as failed within the configuration database and the Storage manager 105 stops attempting to store the fragment in the storage area.

In an example, the Storage manager 105 retrieves a fragment by sending an AGENT_GET_FRAGMENT message to the custom storage agent. This message includes a unique identifier for the fragment. The handler application retrieves the fragment, and calculates a checksum for the data. It then responds to the Storage manager 105 with the fragment data and checksum. The Storage manager 105 then re-calculates the checksum. If the checksum fails to match, the Storage manager 105 re-sends the AGENT_GET_FRAGMENT message a maximum of three times. If the checksum fails after all retries, if the Storage manager receives some other failure code, or if the custom storage agent did not respond in time, the storage area is marked as failed within the configuration database and the Storage manager stops attempting to retrieve fragments from this storage area.

In an example, client components can comprises a “system tray” application (which handles session management, authentication and user preferences), and an integrated context menu which provides backup and restore options to the user. Such a tray application runs when a user logs in to the client system. By default, the user will typically be logged in automatically to the Storage Manager 105 whenever a desktop session is established (or, if required, the user can opt to manually authenticate to the server on the first use of the functionality within a login session), using a CLIENT_LOGIN message. This contains a username, machine name and one or both of the password and private key. If authentication is successful, the Storage manager returns a unique session token for use in subsequent transactions. Otherwise, a failure message is returned. Until successful authentication has taken place, all other operations are unavailable.

When the user logs out of the client system, the tray application sends a CLIENT_LOGOUT message to the Storage manager 105, containing the username, machine name and the session token. This causes the Storage manager 105 to delete the session information, rendering the session token no longer valid. In an example, the client can send a CLIENT_HEARTBEAT message to the Storage Manager 105 every five minutes, to maintain the session token. If this message is not received within ten minutes, the Storage Manager 105 will mark the session as invalid. If this occurs during a user session and the user subsequently attempts a backup or restore operation, the Storage Manager 105 will respond to any messages with a request to re-authenticate. The tray application will then perform re-authentication (prompting the user, if appropriate), prior to the operation being retried. The tray application also makes available a settings dialog (for setting user preferences, including the level of information to display while performing backups or restores) and an option to run a scheduled backup of one or more files in the background.

In addition to the functionality detailed above, the tray application is also capable of generating alerts, in the form of a change to the tray icon (superimposing it with an exclamation mark for example) and an information “balloon”. The level of alert generation is configurable by the user, but might include information on the health of the connection to the Storage Manager, changes to the accessibility/integrity of backed-up fragments, maintenance notices etc.

A number of options are provided to the end user via a context menu according to an example, and which is displayed when a user right-clicks for example on a file upon which an operation is required. The following options can be available:

Backup—this option initiates the backing up of the selected file with the flag set to BACKUP.

Archive—this option initiates the archiving of a file (i.e. its backup and subsequent replacement of the file) with the flag set to ARCHIVE.

Restore Latest—this option initiates the restoration of the latest version of the appropriate file with the version set to LATEST.

Restore Version—this option causes a CLIENT_INIT_RESTORE message to be sent to the Storage Manager, with the version number null. The list of available versions returned from the Storage Manager can be displayed to the user in a dialog box. The user may either choose to select one of the version numbers for restoration, or to cancel the operation. If a version is selected, the CLIENT_INIT_RESTORE message is again sent, this time with the version number set to the appropriate version.

Subject to the user's preferences, a dialog box may be displayed while the appropriate operation is being carried out. This will provide a graphical representation of the progress of the operation.

The system management console is provided by the administration servers and is accessed via a web browser. It provides a range of functionality, dependent upon the role of the user. The functionality available can be broadly divided into three user areas, which are described in the following sections

In an example, individual users with a desktop configured to provide backup and storage system functionality have access to a system management console as an end user via a login to the administration website. Options available to end users include:
Changing personal details, such as email addresses, passwords etc
Generating their own keys for client-server authentication
Downloading the client software
Manually retrieving backed-up files
Defining storage provider preference orders
Viewing logs of their own activities

Typically, power users are users who have the ability to manage other users' accounts as well as their own. Options available to them include all the options for regular end users, but they may be carried out on any user.

System administrators have the ability to manage all user accounts in the same way as power users, but also to carry out fundamental operations affecting the entire system. These options can include:
Adding or removing new storage areas
Installing and configuring custom agents
Taking down or starting up the system
Making the administration interface unavailable/available
Generating authentication keys for Storage manager-agent communications
Viewing all logs, including security logs.
Database administration activities

In addition to the activities listed above, system administrators can also receive system alerts via email. These can be inspected by logging in to the system management console, and include alerts generated by failures of storage areas, storage space nearing capacity, and other critical system messages.

In addition to providing backup services, the system and methods described herein can also support a number of other functions. For example, it is possible to modify the client application so that after it compresses a file during a backup operation, it creates a RAID 5 image of the file prior to transmission. The backup request message will include a flag indicating that the file supports RAID 5. The Storage Manager 105 stores this information in the configuration database for use in the event of a subsequent retrieval failure. In the event that one of the fragments fails to be retrieved, it can return only the recovered fragments, along with an indication of the failure. The client application can then use the additional RAID data in the retrieved fragments to reconstruct the original file, despite the failure. In an example, other levels of RAID could also be appropriate. For example, RAID 1 (mirroring) and RAID 10 (a mirrored RAID 5 array) can be used. Other suitable redundancy schemes can be used as desired.

Furthermore, Implementation of a system can be achieved by automating the storage and retrieval process at session login and logout. The same individual file backup and restore operations would be carried out as described in the previous section, but in the background and without user interaction.

In an example, a Content Delivery Network can be provided by modifying the client system for use by a content publisher. For example, for content delivery files need not be fragmented or encrypted prior to storage and each file can be written into multiple storage locations. A content server can be allocated to handle each storage location and a management server can use a dynamic name resolution system to switch between available content servers, in the event of a server being lost.

An option can be added to the client application whereby the user provides the name of a system which has been lost, stolen or suffered a critical failure and the Storage Manager 105 may use this request to retrieve the specified system's entire file set to the calling system (subject to verification of the user/system combination). Optionally, the calling system can also request to “take over” this file set, which will cause the Storage Manager to re-label all files currently stored for the old system as belonging to the new one.

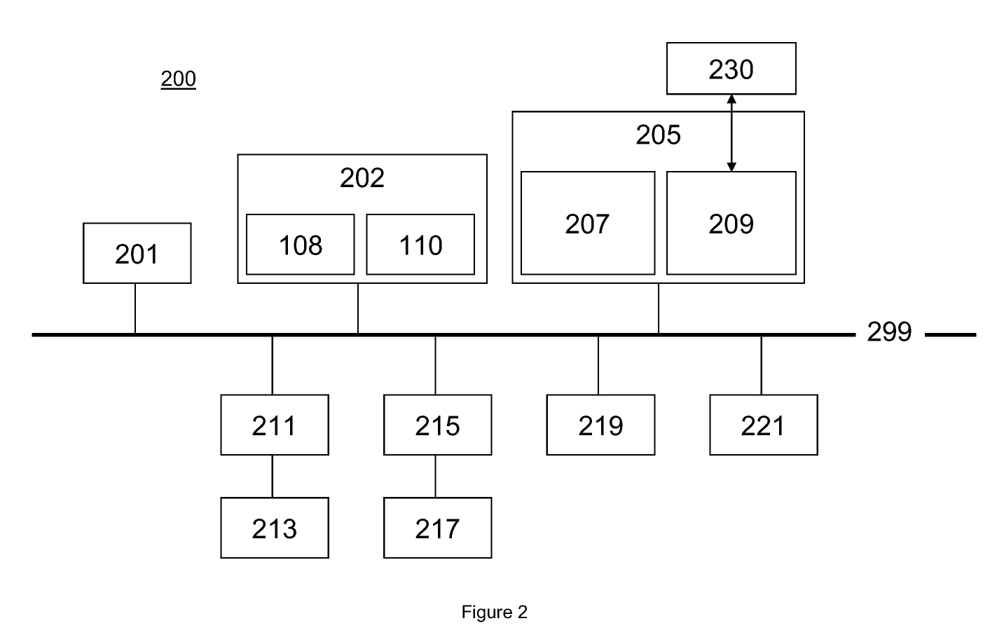

FIG. 2 is a schematic block diagram of a system according to an example, and which is suitable for implementing any of the systems, methods or processes described above. Apparatus 200 includes one or more processors, such as processor 201, providing an execution platform for executing machine readable instructions such as software. Commands and data from the processor 201 are communicated over a communication bus 299. The system 200 also includes a main memory 202, such as a Random Access Memory (RAM), where machine readable instructions may reside during runtime, and a secondary memory 205. The secondary memory 205 includes, for example, a hard disk drive 207 and/or a removable storage drive 230, representing a floppy diskette drive, a magnetic tape drive, a compact disk drive, etc., or a nonvolatile memory where a copy of the machine readable instructions or software may be stored. The secondary memory 205 may also include ROM (read only memory), EPROM (erasable, programmable ROM), EEPROM (electrically erasable, programmable ROM). In addition to software, data representing any one or more of data fragments of files or private-public key pairs for example may be stored in the main memory 202 and/or the secondary memory 205. The removable storage drive 230 reads from and/or writes to a removable storage unit 209 in a well-known manner.

A user can interface with the system 200 with one or more input devices 211, such as a keyboard, a mouse, a stylus, a touch screen device and the like in order to provide user input data for example. The display adaptor 215 interfaces with the communication bus 299 and the display 217 and receives display data from the processor 201 and converts the display data into display commands for the display 217. A network interface 219 is provided for communicating with other systems and devices via a network such as network 101 for example. The system can include a wireless interface 221 for communicating with wireless devices in the wireless community.

It will be apparent to one of ordinary skill in the art that one or more of the components of the system 200 may not be included and/or other components may be added as is known in the art. The system 200 shown in FIG. 2 is provided as an example of a possible platform that may be used, and other types of platforms may be used as is known in the art. One or more of the steps described above may be implemented as instructions embedded on a computer readable medium and executed on the system 200. The steps may be embodied by a computer program, which may exist in a variety of forms both active and inactive. For example, they may exist as software program(s) comprised of program instructions in source code, object code, executable code or other formats for performing some of the steps. Any of the above may be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system hosting or running a computer program may be configured to access, including signals downloaded through the Internet or other networks. Concrete examples of the foregoing include distribution of the programs on a CD ROM or via Internet download. The same is true of computer networks in general. It is therefore to be understood that those functions enumerated above may be performed by any electronic device capable of executing the above-described functions. The system of FIG. 2 can be in the form of mobile device such as a smart device in the form of a mobile telephone or tablet computing device for example. It is typical to interface with such devices using a touch enabled interface in which a user can interact with various icons and other graphical elements by touch gestures via a display of the device. In an example, a typical “long press” touch gesture on graphical element representing a folder or file can be used to present a user with an option to include this in their backup. Other alternatives are possible. For example, other suitable gestures can be used to invoke a backup option.

According to an example, a cloud backup storage manager 108 can reside in memory 202 and operate on data from input sources. Further, a preference file 110 can reside in memory 202.

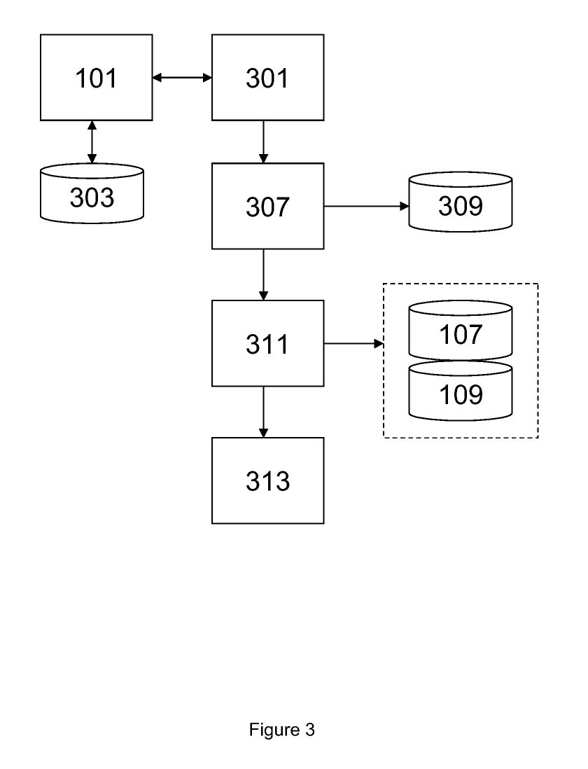

FIG. 3 is flowchart of a method according to an example. The method is implemented at least in part on a system or device such as that described with reference to FIG. 2. In block 301 a local file 303 stored on a client device 101 which is to be backed-up is selected. For example, as described above, a context menu can be invoked (by right clicking the file for example) in which the file is selected by a user for backup. Alternatively, a scheduled backup can be maintained by a system in which certain files or the contents of certain storage locations are periodically backed-up, in which case no user selection need occur other than an initial selection of a file or location to be backed-up on a scheduled basis.

In block 307 the selected file 303 is encoded the file into multiple fragments 309. For example, as described above, a file can be segmented into multiple fragments so that it can later be reconstructed, such as when it is restored to its original location. In block 311 the multiple fragments 309 are transmitted from the client device 101 to a plurality of remote storage areas 107. The remote storage areas can include a network attached storage location 109 and/or third party cloud storage services for example. In block 313 the multiple fragments 309 are stored at the remote storage areas 107, 109.

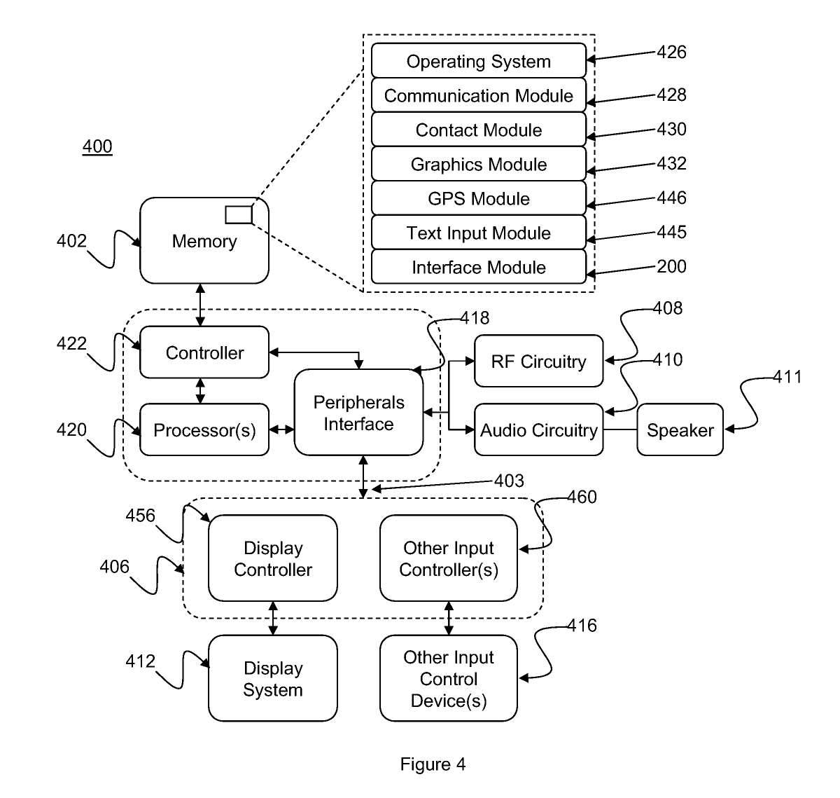

FIG. 4 is a schematic block diagram of a device 400 according to an example. Device 400 can be a mobile terminal such as a mobile telephone or smart phone for example. In other examples, device 400 can be a PDA or tablet computing device. Other alternatives are possible.

In some examples, the device 400 includes a touch-sensitive display system 412. The touch-sensitive display system 412 is sometimes called a “touch screen” for convenience. In other examples, display system 412 can include a non-touch sensitive display such as an LCD or LED display for example. The device 400 may include a memory 402 (which may include one or more computer readable storage mediums), a memory controller 422, one or more processing units (CPU's) 420, a peripherals interface 418, RF circuitry 408, audio circuitry 410, a speaker 411, an input/output (I/O) subsystem 406 and other input or control devices 416. These components may communicate over one or more communication buses or signal lines 403.

It should be appreciated that the device 400 is only one example of a device 400, and that the device 400 may have more or fewer components than shown in FIG. 4, may combine two or more components, or may have a different configuration or arrangement of the components than that shown. The various components shown in FIG. 4 may be implemented in hardware, software or a combination of both hardware and software, including one or more signal processing and/or application specific integrated circuits for example.

Memory 402 may include high-speed random access memory and may also include non-volatile memory, such as one or more magnetic disk storage devices, flash memory devices, or other non-volatile solid-state memory devices. Access to memory 402 by other components of the device 400, such as the CPU 420 and the peripherals interface 418, may be controlled by the memory controller 422.

The peripherals interface 418 couples the input and output peripherals of the device to the CPU 420 and memory 402. The one or more processors 420 run or execute various software programs and/or sets of machine readable instructions stored in memory 402 to perform various functions for the device 400 and to process data.

In some embodiments, the peripherals interface 418, the CPU 420, and the memory controller 422 may be implemented on a single chip, such as a chip 404. In some other embodiments, they may be implemented on separate chips. The RF (radio frequency) circuitry 408 receives and sends RF signals. The RF circuitry 408 converts electrical signals to/from electromagnetic signals and communicates with communications networks and other communications devices via the electromagnetic signals. The RF circuitry 408 may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 408 may communicate with networks, such as the Internet, an intranet and/or a wireless network, such as a cellular telephone and/or data network, a wireless local area network (LAN), and other devices by wireless communication. The wireless communication may use any of a plurality of typical communications standards, protocols and technologies.

The audio circuitry 410 and the speaker 411 provide an audio interface between a user and the device 400. The audio circuitry 410 receives audio data from the peripherals interface 418, converts the audio data to an electrical signal, and transmits the electrical signal to the speaker 411. The speaker 411 converts the electrical signal to human-audible sound waves. Audio data may be retrieved from and/or transmitted to memory 402 and/or the RF circuitry 408 by the peripherals interface 418. In some examples, the audio circuitry 410 also includes a headset jack. The headset jack provides an interface between the audio circuitry 410 and removable audio input/output peripherals, such as output-only headphones or a headset with both output (e.g., a headphone for one or both ears) and input (e.g., a microphone).

The I/O subsystem 406 couples input/output peripherals on the device 400, such as the touch screen 412 and other input/control devices 416, to the peripherals interface 418. The I/O subsystem 406 may include a display controller 456 and one or more input controllers 460 for other input or control devices. The one or more input controllers 460 receive/send electrical signals from/to other input or control devices 416. The other input/control devices 416 may include physical buttons (e.g., push buttons, rocker buttons, etc.), dials, slider switches, joysticks, click wheels, trackpads, touch interface devices and so forth. In some alternate embodiments, input controller(s) 460 may be coupled to any (or none) of the following: a keyboard, infrared port, USB port, and a pointer device such as a mouse. The one or more buttons may include an up/down button for volume control of the speaker 411. The one or more buttons may include a push button or slider control. The touch screen 412 can be used to implement virtual or soft buttons or other control elements and modules for a user interface for example.

The touch-sensitive touch screen 412 can provide an input interface and an output interface between the device and a user. The display controller 456 receives and/or sends electrical signals from/to the touch screen 412. The touch screen 412 displays visual output to the user. The visual output may include graphics, text, icons, video, and any combination thereof. In some embodiments, some or all of the visual output may correspond to user-interface objects, further details of which are described below.

A touch screen 412 can include a touch-sensitive surface, sensor or set of sensors that accepts input from the user based on haptic and/or tactile contact. The touch screen 412 and the display controller 456 (along with any associated modules and/or sets of instructions in memory 402) detect contact (and any movement or breaking of the contact) on the touch screen 412 and converts the detected contact into interaction with user-interface objects that are displayed on the touch screen or another display device. In an example, a point of contact between a touch screen 412 and the user corresponds to a finger of the user.

The touch screen 412 and the display controller 456 may detect contact and any movement or breaking thereof using any of a plurality of typical touch sensing technologies, including but not limited to capacitive, resistive, infrared, and surface acoustic wave technologies, as well as other proximity sensor arrays or other elements for determining one or more points of contact with a touch screen 412.

In some example, software components stored in memory 402 may include an operating system 426, a communication module (or set of instructions) 428, a contact module (or set of instructions) 430, a graphics module (or set of instructions) 432, a GPS module 446 and a text input module 445.

The communication module 428 facilitates communication with other devices over one or more external ports (not shown). The contact/motion module 430 may detect contact with the touch screen 412 (in conjunction with the display controller 456) and other touch sensitive devices (e.g., a touchpad or physical click wheel). The contact module 430 includes various software components for performing various operations related to detection of contact, such as determining if contact has occurred, determining if there is movement of the contact and tracking the movement across the touch screen 412, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., multiple finger contacts). Various touch gestures can be used to invoke backup options and operations. For example, a user touching an icon or other element can invoke selection of an application which can be used to back up a file or folder. Another suitable touch gesture can include a “long hold” in which a user touches an icon or other element and does not stop touching it until a contextual menu (for example) appears. Such a menu can include multiple options for backup such as including selecting a file to be backed up, a location and a backup parameter such as a number of backup locations for example.

The graphics module 432 includes various known software components for rendering and displaying graphics on the touch screen 412, including components for changing the intensity of graphics that are displayed. As used herein, the term “graphics” includes any object that can be displayed to a user, including without limitation text, icons (such as user-interface objects), digital images, videos, animations and the like.

The GPS module 446 can determine the location of the device 400 and provide this information for use in various applications (e.g., for use in location-based dialing, for a camera etc. The GPS module 446 can determine the current location of the device 400 for use in determining the most proximate backup centre for example.

The text input module 445, which may be a component of graphics module 432, can provide a soft keyboard for entering text in various applications for the device 400. For example, a soft keyboard can be used by a user to provide textual input relating to answers to questions posed to the user, such as questions relating to an object to be backed up and a backup location(s), or for the determination of other information which can be used to verify or authenticate the user so that information for or about them can be provided and/or retrieved.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. For example, video player module 445 may be combined with music player module 446 into a single module (e.g., video and music player module). In some examples, memory 402 may store a subset of the modules and data structures identified above. Furthermore, memory 402 may store additional modules and data structures not described above.

What is claimed is:

1. A computer-implemented method of backing up data comprising:
selecting a local file stored on a client device to be backed-up;
encoding the file into multiple fragments;
transmitting the multiple fragments from the client device to a plurality of remote storage areas;
storing the multiple fragments at the remote storage areas.

2. A method as claimed in claim 1, wherein storing the multiple fragments includes storing all the fragments of the file.

3. A method as claimed in claim 1, further including transmitting the multiple fragments to a storage manager, the storage manager to distribute a fragment to a remote storage area.

4. A method as claimed in claim 3, further including transmitting the multiple fragments to a storage manager, the storage manager to distribute a fragment to a remote storage area, and further including encrypting a file fragment prior to distribution from the storage manager.

5. A method as claimed in claim 1, further including maintaining a list of suitable storage areas at the client device

6. A method as claimed in claim 1, further including receiving data at the client device from a remote storage area that a fragment has been successfully received and stored.

7. A system for redundant cloud storage comprising:
a processor coupled to a memory to retain computer-executable instructions, the processor to execute:
a client device component to generate backup data representing a fragment of a data file for backup; and
a cloud backup storage manager to receive the fragment and to distribute it to respective ones of a set of cloud storage devices in accordance with a preference file for selecting multiple ones of cloud storage devices.

8. A system as claimed in claim 7, the client device to compress the backup data and transmit it to the cloud backup storage manager with checksum data for the backup data.

9. A system as claimed in claim 7, the client device to compress the backup data and transmit it to the cloud backup storage manager with checksum data for the backup data, and the cloud backup storage manager to:
validate the checksum data;
identify a cloud storage device for the fragment;
encrypt the fragment; and
transmit the encrypted fragment to the identified cloud storage device for storage.

10. A system as claimed in claim 9, further including a configuration database to receive data from the cloud backup storage manager indicating successful storage of the encrypted fragment at the identified cloud storage device.

11. A system as claimed in claim 7, the cloud backup storage manager to:
provide a success response to the client device to indicate successful storage of the fragment.

12. A computer program embedded on a non-transitory tangible computer readable storage medium, the computer program including machine readable instructions that, when executed by a processor, implement a method for backing up data, comprising:
selecting a local file stored on a client device to be backed-up;
encoding the file into multiple fragments;
transmitting the multiple fragments from the client device to a plurality of remote storage areas;
storing the multiple fragments at the remote storage areas.

13. A computer program embedded on a non-transitory tangible computer readable storage medium as claimed in claim 12, the computer program including machine readable instructions that, when executed by a processor, implement a method for backing up data, wherein storing the multiple fragments includes storing all the fragments of the file.

14. A computer program embedded on a non-transitory tangible computer readable storage medium as claimed in claim 12, the computer program including machine readable instructions that, when executed by a processor, implement a method for backing up data, further including transmitting the multiple fragments to a storage manager, the storage manager to distribute a fragment to a remote storage area.

15. A computer program embedded on a non-transitory tangible computer readable storage medium as claimed in claim 12, the computer program including machine readable instructions that, when executed by a processor, implement a method for backing up data, further including encrypting a file fragment prior to distribution from the storage manager.

16. A computer program embedded on a non-transitory tangible computer readable storage medium as claimed in claim 12, the computer program including machine readable instructions that, when executed by a processor, implement a method for backing up data, further including maintaining a list of suitable storage areas at the client device

17. A computer program embedded on a non-transitory tangible computer readable storage medium as claimed in claim 12, the computer program including machine readable instructions that, when executed by a processor, implement a method for backing up data, further including receiving data at the client device from a remote storage area that a fragment has been successfully received and stored.
